(19) United States
(12) Patent Application Publication
(10) Pub. No.: US 2009/0091942 A1
(43) Pub. Date: Apr. 9, 2009

(54) Lighting system for tow truck

(76) Inventor: Kelly D. Genoe, Pine Knot, KY (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/285,505

(22) Filed: Oct. 7, 2008

Related U.S. Application Data
(60) Provisional application No. 60/960,669, filed on Oct. 9, 2007.

(51) Int. Cl. B60Q 1/00

(52) U.S. Cl. 362/485

(57) ABSTRACT

The lighting system for tow truck includes a housing having lights disposed on a front and sides thereof to illuminate a work area. The lighting system may be disposed on a tow truck accessory frame situated behind a cab of the tow truck. The lights disposed on the housing may be a combination of spotlights and work lights, and are directed to illuminate work areas in the vicinity of the tow truck. This configuration of lights provides greater illumination in work areas to the rear and sides for better control and efficiency of load recovery operations.

### CROSS-REFERENCE TO RELATED APPLICATIONS

This application claims the benefit of U.S. Provisional Patent Application Ser. No. 60/960,669, filed Oct. 9, 2007.

### BACKGROUND OF THE INVENTION

1. Field of the Invention

The present invention relates to vehicle lighting systems, and more particularly to a lighting system for a tow truck that is mountable on a tow truck side puller accessory frame.

2. Description of the Related Art

The present invention relates to a lighting system that can be attached to a tow truck side puller frame or other accessory frame of the truck. In U.S. Patent publication 20040228714, published Nov. 18, 2004, a side puller for the pulling of loads by a car carrier or from a point behind and in close proximity to a cab of the carrier or truck is disclosed. The side puller accessory frame has an accessory frame mounting that mounts the accessory frame to a vehicle frame behind a cab and transverse to the longitudinal axis of the vehicle. A vehicle equipped with the side puller accessory frame may function as a recovery apparatus. The accessory frame includes a powered winch that is equipped with a suitable line, preferably a wire rope, to permit the pulling of a load or loads, such as wrecked cars from accidents and other objects, towards the sides of the recovery apparatus, as well as towards the rear.

The accessory frame preferably includes two manually actuated nesting legs, a wire rope winch fixed to the accessory frame mounting near the center of the accessory frame with the winch transverse to the longitudinal axis of the vehicle. The winch provides pulling force via a removable, pivotal center sheave mounted in a center sheave mounting tube through a top horizontal frame tube. The center sheave directs the pulling force to the sides or rear of the truck as desired or as rigged by a recovery technician, driver, or other user. One limitation of the aforementioned device described in U.S. Patent Application No 20040228714 is that an operator may have difficulty seeing a work area, work tools, the object to be towed, or the like, at nighttime. Heretofore, such nighttime vision problems may have hampered the nighttime use of such a side pulling device.

Thus, a lighting system for a tow truck solving the aforementioned problems is desired.

### SUMMARY OF THE INVENTION

The lighting system for a tow truck includes a housing made of aluminum or stainless steel containing lights to illuminate a work area. The lighting system is disposed on a tow truck side puller accessory frame situated behind the vehicle cab. The lights disposed on the housing may be a combination of spotlights and work lights, and are directed to illuminate the rear of the deck as well as, near and far, side areas away from the deck. This configuration of lights provides greater illumination in work areas to the rear and sides for better control and efficiency.

These and other features of the present invention will become readily apparent upon further review of the following specification and drawings.

### BRIEF DESCRIPTION OF THE DRAWINGS

FIG. 1 is an environmental, perspective view of a lighting system for tow truck according to the present invention.

FIG. 2 is a partially exploded, perspective view of the lighting system for tow truck according to the present invention.

FIG. 3 is a schematic wiring diagram of the lighting system for tow truck according to the present invention. Similar reference characters denote corresponding features consistently throughout the attached drawings.

### DETAILED DESCRIPTION OF THE PREFERRED EMBODIMENTS

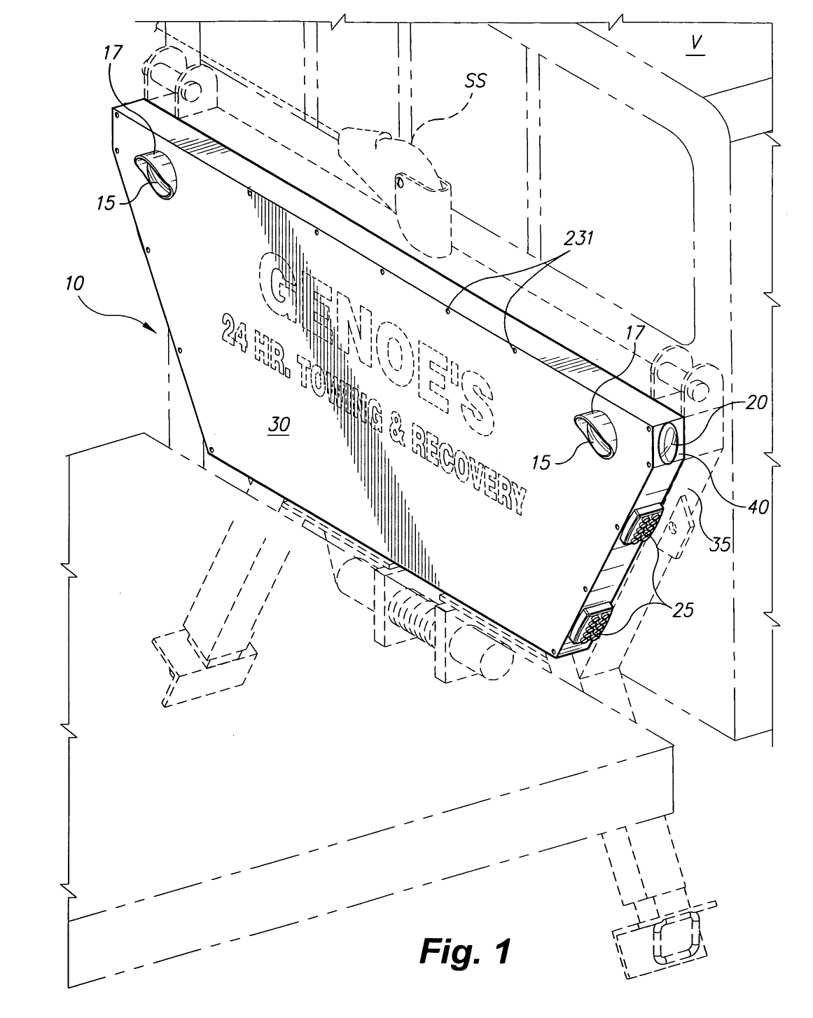

As shown in FIG. 1, the present invention is a lighting system 10 mountable on a vehicle V and includes a wiring harness/cable enclosure, which may preferably be made of aluminum or stainless steel. The wiring harness/cable 60 is electrically connected to a plurality of lights disposed on or within the enclosure and arranged to illuminate a variety of work areas of interest around the vehicle. The enclosure may be disposed on a tow truck, rollback, or other work vehicle immediately behind the vehicle cab. The enclosure may be attached to a frame accessory of the vehicle V, such as, for example, a side puller SP. The plurality of lights may include rear directed spotlights 15, side directed spotlights 20, and side work lights 25. The configuration of lights provides greater illumination in the work area and to the sides for better control and efficiency during recovery operations using towing vehicle winch accessories, and the like. Light shields 17 may be disposed over lamps 15 to assist in directing the light away from the panel 30.

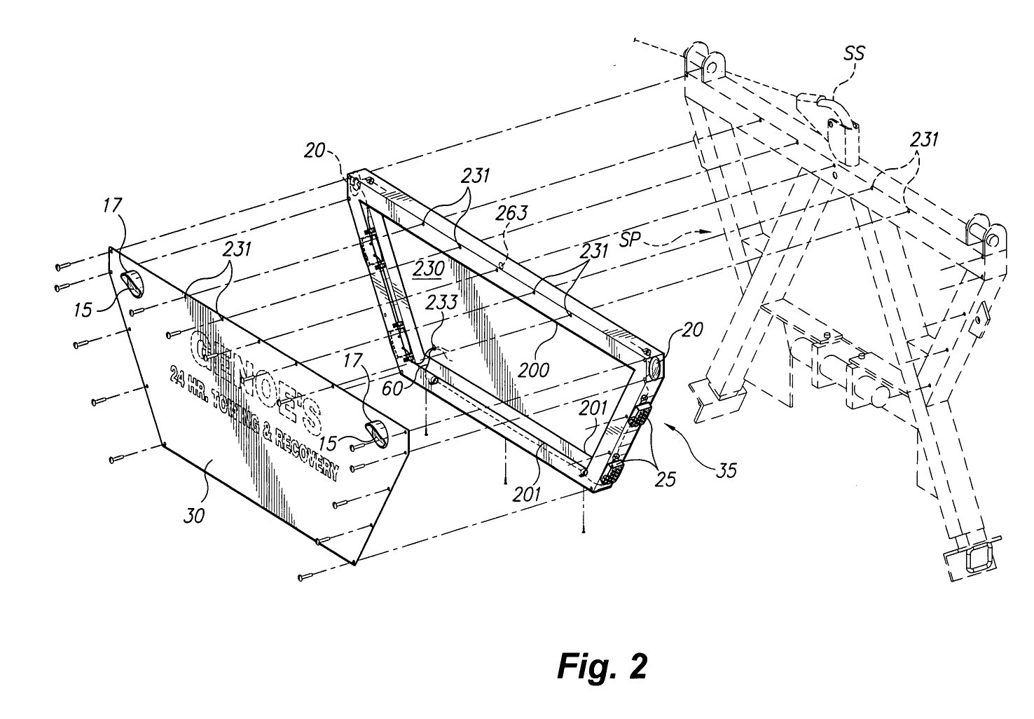

The side work lights 25 are angled down with respect to a horizontal plane, and, as shown in FIGS. 1-2, two side work lights 25 are provided on each side of the vehicle V. The side spotlights 20 (at least one for each side of the vehicle) are directed horizontally and are disposed above the side work lights 25.

The housing may be of unitary construction, or as shown in FIGS. 1-2 may be formed from a front panel 30, a plurality of angled side panels 35, a plurality of vertical side panels 40, and a rear panel 230, all joined together. Optionally, the front panel may have cutouts that form advertising indicia or other signage that may be illuminated by neon lights from inside the enclosure of lighting system 10. The panels may be joined and reinforced via an internal C-shaped channel frame 200. Side panels 35 and 40 may be formed as an integral part of channel frame 200. The C-shaped channel of frame 200 provides a trough in which the wiring 60 may be disposed and routed to lighting elements 15, 20 and 25. Sidewalls 201 of the C channel frame 200 provide anchoring locations to which the panel elements 30, 35, 40, and 230 may be fastened, welded, or otherwise attached to the C channel frame 200.

Matching sets of mounting bores 231 are disposed in rear panel 230, C channel frame 200 and front panel 30. The bores 231 are provided so that bolts, screws, or the like may be fitted through the system 10 and threaded or otherwise fastened into a frame accessory such as, e.g., side puller frame SP, to fasten the lighting system 10 thereto. Additionally, a cable through bore 233 is provided so that wiring cables can be routed outside of the enclosure to connect to a lighting power source and associated switches on the vehicle V. In the embodiment shown, a single grease fitting bore 263 is disposed proximate a top center portion of the rear panel 230. The grease fitting bore 263 is used for access of a grease gun to a central swiveling sheave SS of side puller frame SP without having to remove the system 10 in the event that the system 10 has been installed on a side puller frame SP.

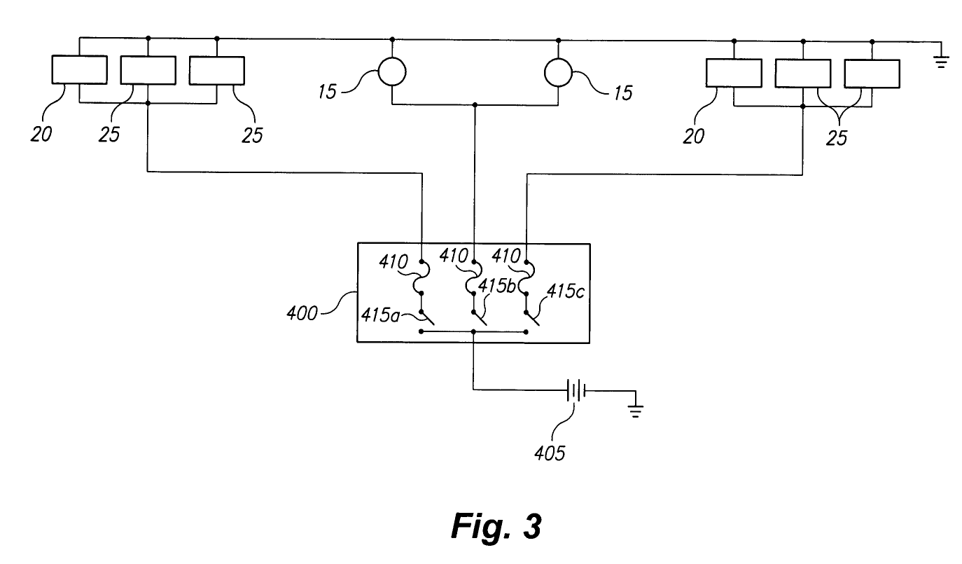

The lights 15, 20, and 25 may be wired via cable 60 as shown in FIG. 3. Lighting groups are wired in parallel, so that if any one light burns out the others in that group can still be energized. Wiring can be terminated in a switch box 400. The switch box 400 may contain fuses 410 (preferably 20 amperes) and a plurality of switches, such as switches 415a, 415b, and 415c. Each switch controls a different lighting group. For example, a left side lighting group (including two lights 25 and light 20) may be controlled by switch 415a, a similarly equipped right side lighting group may be controlled by switch 415c, and a central lighting group (including lights 15) may be controlled by switch 415b. Common pole of the switches is wired to a lighting power source such as battery 405, or the like. For convenience, switchbox 400 may be disposed in the cab of the vehicle V.

It is to be understood that the present invention is not limited to the embodiment described above, but encompasses any and all embodiments within the scope of the following claims.

I claim:

1. A lighting system for a tow truck, comprising:
a side puller frame adapted for mounting on a tow truck, the side puller frame having at least one winch and sheave assembly for pulling a towed vehicle from a variety of angles in relation to the tow truck;
a housing having a front surface, a plurality of side surfaces, and a rear surface, the housing being mounted on the side puller frame; and
a plurality of lights disposed on the side and front surfaces of the housing, the lights being positioned to illuminate work areas in the vicinity of the sides and front of the housing.

2. The lighting system according to claim 1, further comprising an electrical cable disposed within the housing, the cable being electrically connected to the lights for selective illumination of the different work areas.

3. A lighting system attachable to a vehicle accessory frame, the lighting system comprising:
a housing having a front surface, a plurality of side surfaces, and a rear surface; and
a plurality of lights disposed on the side and front surfaces of the housing, the lights being positioned to illuminate different work areas around the sides and front of the housing.

4. The lighting system according to claim 3, further comprising an electrical cable disposed within the housing, the cable being electrically connected to the lights for selective illumination of the different work areas.

5. The lighting system according to claim 3, wherein the housing is made of stainless steel.

6. The lighting system according to claim 3, wherein the housing is made of aluminum.

7. The lighting system according to claim 3, wherein the plurality of lights includes rear-directed spotlights, side-directed spotlights, and side-directed work lights.

8. The lighting system according to claim 3, further comprising light shields disposed over the lights, the light shields assisting in directing illumination away from the vehicle upon which the lights are mounted.

9. The lighting system according to claim 3, wherein the lights on the side surfaces are angled downward with respect to a horizontal plane.

10. The lighting system according to claim 3, wherein the housing has a front panel and a rear portion formed in a unitary construction.

11. The lighting system according to claim 3, wherein groups of the plurality of lights are wired in parallel.

12. The lighting system according to claim 3, further comprising:
a switch box; and
wiring connected to the lights, the wiring terminating within the switch box; and
a plurality of switches, each switch of the plurality of switches controlling a different group of the lights.
